(19) United States
(12) Patent Application Publication
(10) Pub. No.: US 2010/0136852 A1
(43) Pub. Date: Jun. 3, 2010

(54) Press-Fitted Terminal, Terminal Press Fitting Structure, and Electric Connector

(76) Inventor: Yusuke Mito, Tokyo (JP)

Correspondence Address: BARLEY SNYDER, LLC, 1000 WESTLAKES DRIVE, SUITE 275, BERWYN, PA, 19312, US

(21) Appl. No.: 12/702,940

(22) Filed: Feb. 9, 2010

Related U.S. Application Data
(63) Continuation of application No. PCT/JP2008/064128, filed on Aug. 6, 2008.

(30) Foreign Application Priority Data
Aug. 10, 2007 (JP) 2007-210190

(51) Int. Cl. H01R 13/40; H01R 13/02

(52) U.S. Cl. 439/733.1; 439/884

(57) ABSTRACT

A press-fit terminal that is press-fit forward into a receiving passageway formed in an insulator. The press-fit terminal having a fixing section and a plurality of projections. The plurality of projections positioned along the fixing section and protruding in a direction crossing a press-fit direction of the press-fit terminal. Each of the plurality of projections interfere with inner surfaces of the receiving passageway when the press-fit terminal is press-fit, and are aligned in the press-fit direction. Tips of the plural projections and depressions between the plural projections in the fixing section are both rounded, and each of the plural projections has such a shape that slopes forward of the respective tips are slanted more gently than slopes backward of the respective tips.

### CROSS-REFERENCE TO RELATED APPLICATIONS

This application is a continuation of PCT International Application No. PCT/JP2008/064128, filed August 6, 2008, which claims priority under 35 U.S.C. §119 to Japanese Patent Application No. JP 2007-210190, filed August 10, 2007.

### FIELD OF THE INVENTION

The present invention relates to electrical connectors and more particularly, to a press-fit terminal to be press-fit into a receiving passageway formed in an insulator, and a terminal press-fitting structure.

### BACKGROUND

There are known electrical connectors having a structure in which a terminal is press-fit into a receiving passageway of an insulating housing formed by an insulator. For example, Japanese Patent Laid-Open No. 2005-135794 describes a press-fitting structure composed of an insulator and a terminal press-fit into this insulator. In the terminal, a number of removal-preventing projections are formed. These removal-preventing projections are shaped like teeth of a saw with sharp points. This removal-preventing projection functions as a barb by contacting an inner surface of the receiving passageway when the terminal is press-fit into the insulator.

However, in the press-fitting structure of Japanese Patent Laid-Open No. 2005-135794, when the terminal is press-fit into the insulator, the inner surface of the receiving passageway is chipped and/or deformed plastically and thus, the receiving passageway remains in an expanded condition. In the state in which the receiving passageway remains expanded, digging of the terminal into the inner surface of the receiving passageway is insufficient and thus, there is a problem in that a sufficient holding power of the terminal is not achieved even though the removal-preventing projections that function as barbs are provided. Here, the holding power refers to a force required for pulling the press-fit terminal from the insulator.

FIG. 8 and FIG. 9 illustrate cross-sectional views in which a known terminal is press-fit into a receiving passageway of an insulator in a conventional terminal press-fitting structure. FIG. 8 and FIG. 9 sequentially illustrate steps in which the known terminal is press-fit into the receiving passageway of the insulator from Part (A) to Part (E). Incidentally, in FIG. 8 and FIG. 9, a part of each of the terminal and the insulator is illustrated and hatching of the insulator is omitted so that the views are easy to see.

A terminal 91 shown in FIG. 8 is made of metal, shaped like a rod, and inserted forward (F) into a receiving passageway 921 formed in an insulator 92. Six projections 931, 932, 933, 934, 935 and 936 that contact the inner surfaces 922 and 923 of the receiving passageway 921 are formed on both sides of the middle of the terminal 91. Each of the projections has a shape with a sharp point. When the terminal 91 is press-fit into the insulator 92, these projections 931 through 936 function as barbs. In other words, the projections 931 through 936 are not caught on the inner surfaces 922 and 923 of the receiving passageway 921 at the time of the insertion of the terminal 91, but when the terminal 91 is pulled to be removed, the projections 931 through 936 are caught on and dig into the inner surfaces 922 and 923 of the receiving passageway 921. Part (A) of FIG. 8 illustrates a state in which the terminal 91 is inserted halfway into the receiving passageway 921 of the insulator 92, but the projections 931 through 936 have not yet interfered with the inner surfaces 922 and 923 of the receiving passageway 921.

As shown in Part (B) of FIG. 8, when the terminal 91 is further pushed in forward (F), the projections 931 and 934, which are provided forward (F) among the six projections 931 through 936, contact and interfere with the inner surfaces 922 and 923 of the receiving passageway 921. The inner surfaces 922 and 923 of the receiving passageway 921 are pushed in by the projections 931 and 934, in a direction of going away from the press-fit terminal 91, and deformed to expand the receiving passageway 921. Usually, the inner surfaces 922 and 923 of the receiving passageway 921 experience plastic deformation, while the tips of the projections 931 and 934 are passing therethrough. Also, the inner surfaces 922 and 923 of the receiving passageway 921 are chipped by the passage of the tips of the projections 931 and 934. Therefore, backward (B) of the tips of the projections 931 and 934, space is formed between the inner surfaces 922, 923 of the receiving passageway 921 and the projections 931, 934, causing a state in which digging of the projections 931 and 934 into the inner surfaces 922 and 923 of the receiving passageway 921 is not sufficient.

As shown in Part (C) and Part (D) of FIG. 9, when the terminal 91 is further pushed in forward (F), the projections 932 and 935 provided in the middle and the projections 933 and 936 (provided farther backward (B)) interfere with the inner surfaces 922 and 923 of the receiving passageway 921. However, as for the projections 932 and 935 provided in the middle and the projections 933 and 936 provided backward (B) as well, the projections 932 and 935 that dig into the inner surfaces 922 and 923 of the receiving passageway 921 are insufficient. Also, because of the chipping and plastic deformation by the projections 931 and 934 that have passed earlier, the digging of the projections 932 and 935, which are provided in the middle and the projections 933 and 936 provided backward (B) into the inner surfaces 922 and 923 of the receiving passageway 921, becomes further insufficient.

When the terminal 91 is further pushed in forward (F), press-fitting of the terminal 91 is completed in a state shown in Part (E) of FIG. 9. In the state shown in Part (E), the terminal 91 by the insulator 92 is not sufficiently held and secured. Therefore, for example, there is a possibility that the terminal 91 might be removed from the insulator 92 upon receipt of a force exerted backward (B).

### SUMMARY

In view of the foregoing circumstances, it is an object of the present invention, among other objects, to provide a press-fit terminal which is secured by an insulator more firmly and a press-fitting structure of an electrical connector in which this press-fit terminal is press-fit into the insulator.

The press-fit terminal includes a fixing section and a plurality of projections. The plurality of projections are positioned along the fixing section and are engageable with an inner surface of a receiving passageway, when the press-fit terminal is press-fit. Furthermore, the plurality of projections are aligned in the press-fit direction while protruding in a direction crossing a press-fit direction of the press-fit terminal. Each of the plurality of projections includes tips that are rounded, while depressions are positioned between the plurality of projections. The depressions are rounded, as well. Each of the plurality of projections has a shape that includes a slope forward of the tip that is more gently slanted than a slope backward of the tip.

### BRIEF DESCRIPTION OF THE DRAWINGS

Further details, advantages and features of this invention are given in the following description of an embodiment, in association with the drawings. In these drawings:

FIG. 1 is a perspective view of an assembly of an electrical connector according to the present invention;

FIG. 2 is a cross-sectional view showing a part of a cross section of the electrical connector shown in FIG. 1, taken along a 2-2 line in an assembled state;

FIG. 3 is an enlarged view showing a fixing section of a press-fit terminal shown in FIG. 1;

FIG. 4 is a partial cross-sectional view showing a cross section of an insulating housing shown in FIG. 1, taken along the line 2-2;

FIG. 5 illustrates cross-sectional views in a process in which the press-fit terminal shown in FIG. 1 is press-fit into the insulating housing;

FIG. 6 illustrates cross-sectional views of press-fitting steps subsequent to FIG. 5;

FIG. 7 is a table showing press-fit terminal holding power of each press-fit terminal according to an example and comparative examples 1 and 2;

FIG. 8 illustrates cross-sectional views in a process in which a known terminal is press-fit into a receiving passageway of an insulator in a conventional terminal press-fitting structure;

FIG. 9 illustrates cross-sectional views of press-fitting steps subsequent to FIG. 8.

### DETAILED DESCRIPTION OF THE DRAWINGS

### Embodiment(s)

An embodiment of the present invention will be described below with reference to the drawings.

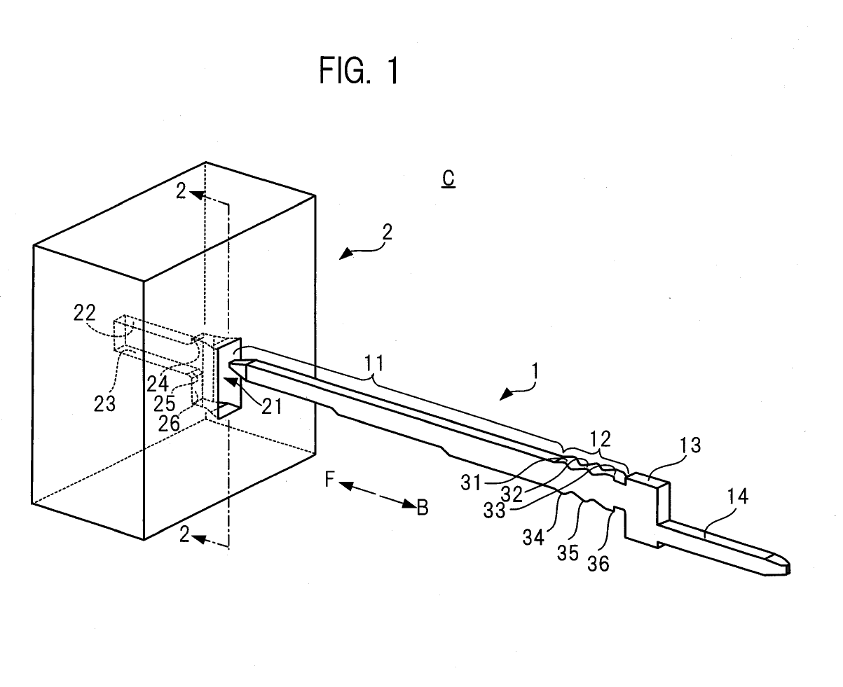

FIG. 1 is an assembly drawing illustrating an electrical connector C having a press-fit terminal 1 (hereinafter simply referred to as press-fit terminal 1) that establishes electrical connection with a mating connector not shown, and an insulating housing 2 that holds this press-fit terminal 1.

The insulating housing 2 is made of an insulator such as synthetic resin or other suitable insulative material and a receiving passageway 21 into which the press-fit terminal 1 is to be press-fit is formed therein. The press-fit terminal 1 is made of a metallic material, shaped like a rod, and penetrates the insulating housing 2 to be attached thereto.

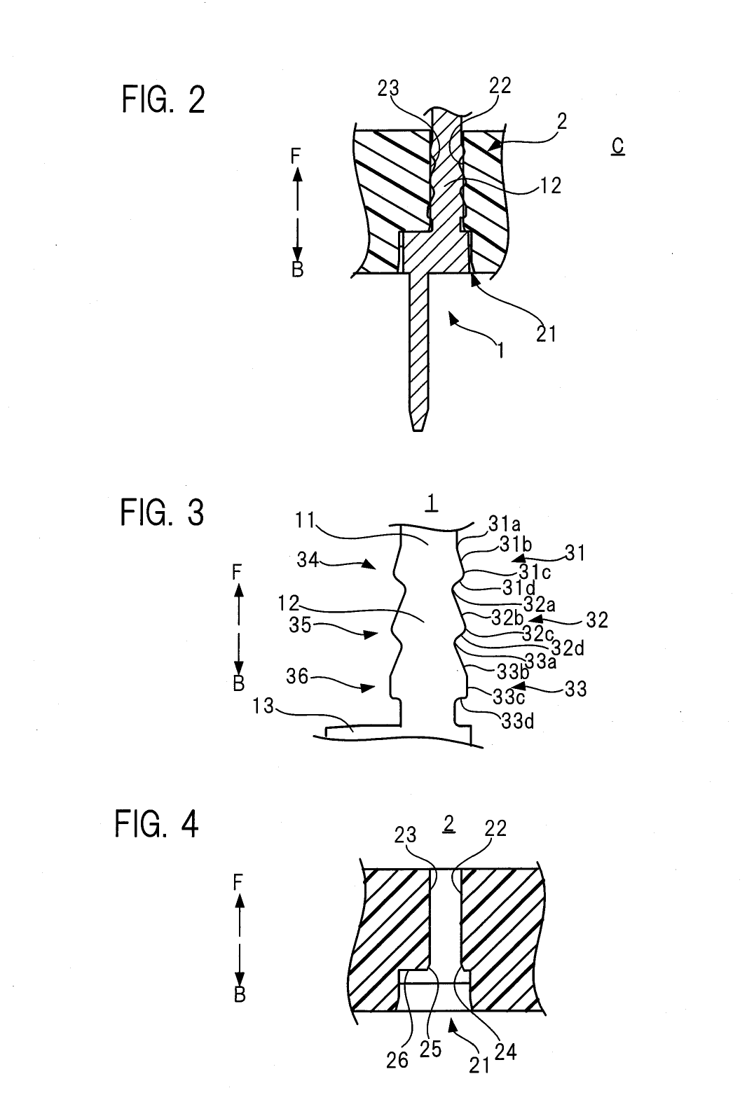

As shown in FIG. 2, the electrical connector C is completed the press-fit terminal 1 is fully press-fit into the receiving passageway 21 of the insulating housing 2. In the present embodiment, the direction in which the press-fit terminal 1 is press-fit into the insulating housing 2 is a forward direction F, and the direction opposite thereto is a backward direction B. Incidentally, FIG. 1 illustrates the press-fit terminal 1 as a single terminal to explain the terminal press-fitting structure in an easy-to-understand way. However, in the terminal press-fitting structure and the electrical connector of the present invention, a single press-fit terminal 1 or two or more press-fit terminals may be press-fit into an insulator.

The press-fit terminal 1 is formed by subjecting a metal plate to stamping or the like. The press-fit terminal 1 includes a contact section 11, a fixing section 12, an offset section 13, and a connection section 14. The contact section 11 that protrudes forward (F) from the insulating housing 2 in a press-fitting completed state in which the press-fitting of the press-fit terminal 1 into the insulating housing 2 is completed. The fixing section 12 provided adjacent to the contact section 11 and formed to have a waveform interfering with inner surfaces 22 and 23 of the receiving passageway 21 of the insulating housing 2. The offset section 13 provided adjacent to the fixing section 12 and formed to be wider than the contact section 11 and the fixing section 12. The connection section 14 provided adjacent to the offset section 13 and protruding backward (B) from the insulating housing 2 in the press-fitting completed state without being inserted into the insulating housing 2.

The press-fit terminal 1 is a so-called off-set type of terminal and has such a shape that the contact section 11, having the fixing section 12, and the connection section 14 extend along the respective lines shifted from each other with reference to the offset section 13. In a state in which the press-fitting of the press-fit terminal 1 into the insulating housing 2 is completed and they function as the electrical connector C, electrical connection is established by contact of the contact section 11 provided on a front-end side of the press-fit terminal 1 with a mating connector (not shown). Also, the connection section 14 on a rear-end side of the press-fit terminal 1 is connected to a substrate or the like not illustrated.

The fixing section 12 of the press-fit terminal 1 has six projections 31, 32, 33, 34, 35 and 36 that contact and interfere with the inner surfaces 22 and 23 of the receiving passageway 21 when the press-fit terminal 1 is press-fit. The projections 31 through 36 are divided into and provided on opposite sides of the fixing section 12 and protrude along a press-fit direction in which the press-fit terminal 1 is press-fit, namely, a direction crossing the forward and backward directions F and B. The three projections 31, 32 and 33 of the six projections 31 through 36 are arranged abreast along the forward and backward directions F and B, and opposite to these three projections 31, 32 and 33. The remaining three projections 34, 35 and 36 are arranged abreast along the forward and backward directions F and B.

With reference to FIG. 3, the fixing section 12 of the press-fit terminal 1 is shown, and formed to be symmetrical about an axis along the forward and backward directions F and B. On one side of the fixing section 12, the three projections 31, 32 and 33 are arranged abreast in the forward and backward directions F and B. Each of the projections 31, 32 and 33 projects in a direction crossing the forward and backward directions F and B, and those provided further backward (B) have larger tips. In other words, a tip 33c of the projection 33 on a backward (B) side is formed to be larger than a tip 32c of the projection 32 in the center, and the tip 32c of the projection 32 in the center is formed to be larger than a tip 31c of the projection 31 on a forward (F) side. Also, each of the tips 31c, 32c and 33c of the projections 31, 32 and 33 is rounded, and a depression 32a formed between the projection 31 and the projection 32 and a depression 33a formed between the projection 32 and the projection 33 also are rounded. A boundary 31a between the projection 31 on the forward (F) side and the contact section 11 also is rounded. Here, being rounded means that contours along the forward and backward directions F and B are smoothly connected without having acute angles and that besides portions whose contours are formed by only curves, portions whose contours have straight lines are included. In other words, the fixing section 12 is formed to have a smooth shape along the three projections 31, 32 and 33. Specifically describing each of the projections 31, 32 and 33, linear parts are included in slopes 31b, 32b and 33b forward (F) of the tips 31c, 32c and 33c and slopes 31d, 32d and 33d backward (B) of the tips 31c, 32c and 33c. Also, the tip 33c of the projection 33 on the backward (B) side has a linear part, parallel to the forward and backward directions F and B, to increase a resistance to the tip 33c of the press-fit terminal 1 press-fit into the insulating housing 2. Also, the projections 31, 32 and 33 are respectively formed such that the slopes 31b, 32b and 33b forward (F) of the tips 31c, 32c and 33c are more subtle than the slopes 31d, 32d and 33d backward (B) of the tips 31c, 32c and 33c.

The three projections 31, 32 and 33 provided on the one side of the fixing section 12 have been described. The three projections 31, 32 and 33 are provided to have symmetry with the three remaining projections 34, 35 and 36 provided on the other side of the fixing section 12. The shapes of the projections 34, 35 and 36 are similar to those of the projections 31, 32 and 33 described above and thus description thereof will be omitted.

The insulating housing 2 will be described with reference to FIG. 1 and FIG. 4.

With reference to FIG. 4, in the middle of the receiving passageway 21 of the insulating housing 2, a step section 26 is formed. A part of the receiving passageway 21, backward (B) of the step section 26, is formed to be wide to the extent of accommodating the offset section 13 of the press-fit terminal 1, and a part of the receiving passageway 21, forward (F) of the step section 26, is formed to have a width slightly smaller than the width of the fixing section 12 of the press-fit terminal 1. The press-fit terminal 1 press-fit into the receiving passageway 21 of the insulating housing 2 is positioned by abutment of the offset section 13 against the step section 26. The fixing section 12 of the press-fit terminal 1 contacts and engages with the inner surfaces 22 and 23 on a side forward (F) of the step section 26 of the receiving passageway 21. Formed at rear ends of the inner surfaces 22 and 23 of the receiving passageway 21 are chamfers 24 and 25 slanting toward the backward (B) direction, and opening wide. When the press-fit terminal 1 is inserted into the receiving passageway 21 of the insulating housing 2, the chamfers 24 and 25 guide the tip of the press-fit terminal 1 to an inside of the receiving passageway 21.

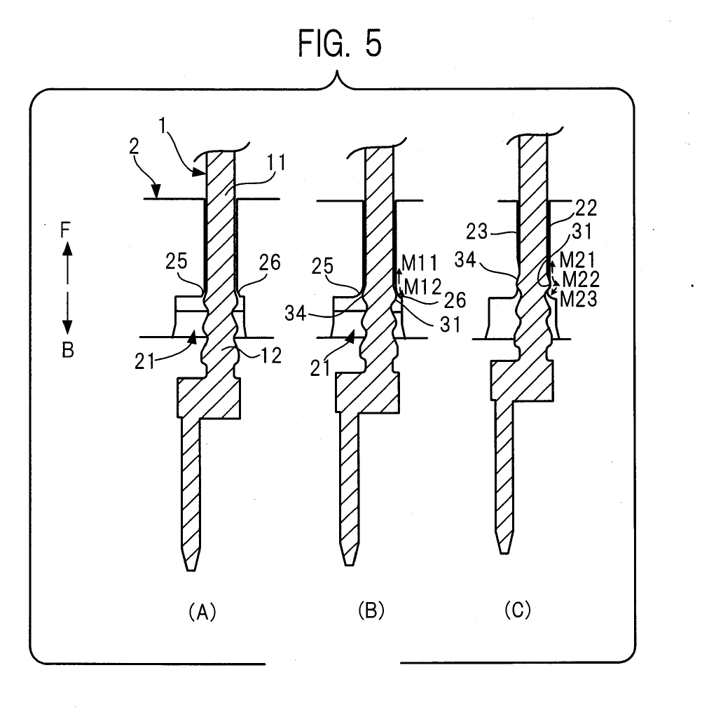

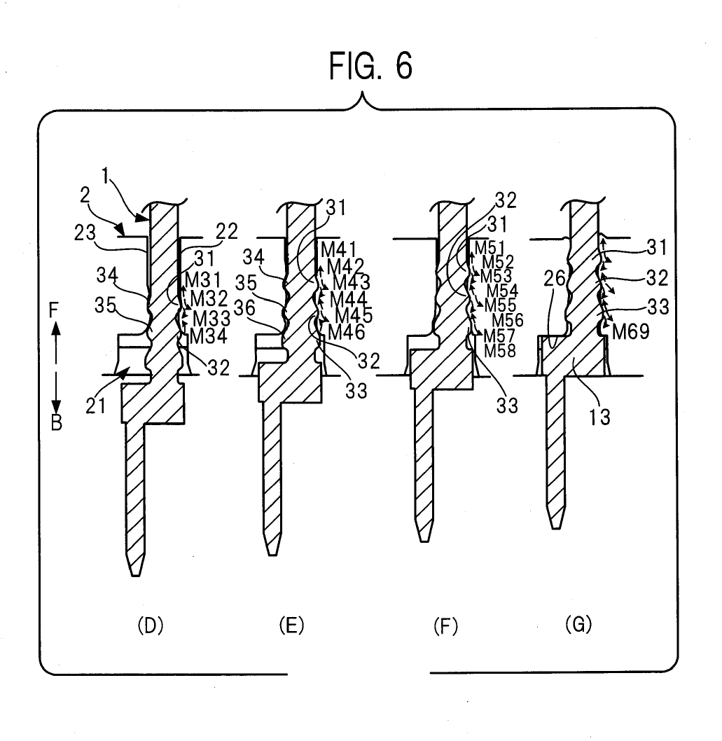

In Part (A) through Part (B) of FIG. 5 and FIG. 6, steps through which the press-fit terminal 1 is press-fit into the insulating housing 2 are sequentially shown by way of cross-sectional views taken along the line 2-2 in FIG. 1. Incidentally, hatching of the insulating housing 2 is omitted so that a deforming state of the insulating housing 2 is easy to see.

As shown in Part (A) of FIG. 5, when the press-fit terminal 1 is inserted into the receiving passageway 21 of the insulating housing 2 and pushed in forward (F), the contact section 11 of the press-fit terminal 1 protrudes forward (F) from the insulating housing 2. Also, the fixing section 12 of the press-fit terminal 1 is pressed against the chamfers 24 and 25.

Meanwhile, when the press-fit terminal 1 is further pushed in forward (F) as shown in Part (B) of FIG. 5, the projections 31 and 34 on the forward (F) side of the press-fit terminal 1 advance forward (F) while pushing and expanding the chamfers 24 and 25 toward opposite sides. The part of the insulating housing 2, which part is pressed against the projection 31, deforms to move forward (F) as shown with an arrow M11, and deforms to be pushed in along a direction of going away from the press-fit terminal 1 in the vicinity of the tip 31c of the projection 31 as shown with an arrow M12. Because the chamfers 24 and 25 are shaped to slant open-wide in the backward (B) direction, chipping, which occurs when the inner surfaces 22 and 23 of the receiving passageway 21 are abutted and pushed inward by the projection 31, as well as plastic deformation, due to concentration of stress, are suppressed. Incidentally, of the press-fit terminal 1 and the insulating housing 2, deformation of the insulating housing 2 has been described by focusing on the one side where the projection 31 is provided. However, the projection 34 on the other side is formed to have symmetry with the projection 31, and deformation of the insulating housing 2 on the other side where the projection 34 is provided is similar to that on the side where the projection 31 is provided. In the following, only the one side will be mainly described and description of the other side will be omitted.

As shown in Part (C) of FIG. 5, when the press-fit terminal 1 is further pushed in forward (F), the projections 31 and 34 as a whole engage and interfere with the inner surfaces 22 and 23 of the receiving passageway 21. At this moment, a part of the insulating housing 2, against which part the slope 31b (see FIG. 3) forward (F) of the tip 31c (see FIG. 3) of the projection 31 is abutted, slightly deforms forward (F), as shown with an arrow M21, and slightly deforms in the vicinity of the tip 31c of the projection 31 in a direction of being pushed in as shown with an arrow M22. The tip 31c of the projection 31 has a round shape and thus, a force applied to the inner surface 22 of the receiving passageway 21 disperses over the surroundings of the tip 31c. For this reason, deformation of the inner surface 22 of the receiving passageway 21, in the vicinity of the tip 31c, remains in the extent of elastic deformation, while plastic deformation is suppressed. The plastic deformation is also suppressed by the fact that the slope 31b (see FIG. 3) forward (F) of the tip 31c have such a shape that the slope 31b is slanted more gently than the slope 31d backward (B) is slanted. As a result, of the inner surface 22 of the receiving passageway 21, a part through which the tip 31c (see FIG. 3) of the projection 31 has passed returns toward the press-fit terminal 1 along the round shape of the tip 31c as shown with an arrow M23.

As shown in Part (D) of FIG. 6, when the press-fit terminal 1 is further pushed in forward (F), the projections 32 and 35 in the center also interfere with the inner surfaces 22 of the receiving passageway 21. Of the inner surface 22 of the receiving passageway 21, a part with which the projection 31 on the forward (F) side interferes deforms (arrows M31, M32 and M33) in a manner similar to the deformation indicated by the arrows M21, M22 and M23 in Part (C) of FIG. 5. Of the insulating housing 2, a part on which the slope 31b forward (F) of the tip 31c (see FIG. 3) of the projection 32 in the center is abutted deforms forward (F) as shown with an arrow M34. By both the deformation (M33) going over the projection 31 on the forward (F) side and returning toward the press-fit terminal 1 and the deformation (M34) produced by pushing out by the projection 32 in the center, there is increased the amount of a return of the inner surface 22 of the receiving passageway 21 toward the depression 32a (see FIG. 3) between the projection 31 on the forward (F) side and the projection 32 in the center. Also, of the deformation by the projection 31 on the forward (F) side, a part which deforms plastically to a small extent does not return to the original state even after going over the projection 31 and therefore, the receiving passageway 21 remains expanded, as compared to an unexpanded state before the passage of the projection 31. However, because the projection 32 in the center has the tip 32c larger than the projection 31 on the forward (F) side, the projection 32 intimately contacts, over a wide area, the inner surface 22 of the receiving passageway 21.

As shown in Part (E) and Part (F) of FIG. 6, when the press-fit terminal 1 is further pushed in forward (F), the projections 33 and 36 on the backward (B) side interfere with the inner surface 22 of the receiving passageway 21. In Part (E) and Part (F) of FIG. 6, of the insulating housing 2, deformation (M41, M42, M43, M51, M52 and M53) by the projection 31 on the forward (F) side of the press-fit terminal 1 is similar to the deformation (M31, M32 and M33) by the projection 31 in Part (D). Also, the deformation (M44, M45, M46, M54, M55 and M56) by the projection 32 in the center in Part (E) and Part (F) of FIG. 6 occurs based on a mechanism similar to that of the deformation (M41, M42, M43, M51, M52 and M53) by the projection 31 on the forward (F) side. In the state shown in Part (F) of FIG. 6, deformation caused by the projection 33 on the backward (B) side indicated by arrows M57 and M58 is added.

As shown in Part (G) of FIG. 6, when the press-fit terminal 1 is further pushed in forward (F), the offset section 13 abuts against the step section 26, completing press-fitting of the press-fit terminal 1. In the state shown in Part (G) of FIG. 6, the terminal press-fitting structure in the electrical connector in which the press-fit terminal 1 is press-fit into the insulating housing 2 is completed. In the state shown in Part (G) of FIG. 6, of the inner surface 22 of the receiving passageway 21, a part that has gone over the tip 33c (see FIG. 3) of the projection 33 on the backward (B) side returns toward the press-fit terminal 1 as shown with an arrow M69.

In this way, plastic deformation of the insulating housing 2 by the projections 31 through 36 of the press-fit terminal 1 is suppressed, and the part that has gone over the projection (31 through 36) by elastic deformation returns to enter the depression between the projections (31 through 36). Therefore, the intimate-contact area between the fixing section 12 of the press-fit terminal 1 and the inner surfaces 22 and 23 is increased, and the frictional force produced by clamping of the terminal by the insulating housing 2 is increased. Further, removal prevention by the asymmetrical shape of the projections 31-36 synergistically affects this increase in frictional force, making for a more secure hold of the press-fit terminal 1 by the insulating housing 2.

Plastic deformation is included in the deformation of the internal surfaces 22, 23 of the receiving passageway 21, which is pressed and expanded. As a result, even when the deformed state caused by the press and expansion by the projection (i.e. projection 31, 32, 34, 35) does not return to the original state completely, the next projection (i.e. 34, 35, 33, 36) having the tip (i.e. 34c, 35c, 33c, 36c) larger than that of the projection (i.e. projection 31, 32, 34, 35) that has passed earlier is clamped by the inner surface 22, 23 of the receiving passageway 21.

Subsequently, there will be described an example in which a terminal having the shape of the above-described embodiment is prepared and the holding power of the press-fit terminal 1 in a state in which the terminal is press-fit into an insulating housing 2 is obtained.

First, as a sample of the example, there is prepared a press-fit terminal 1 having the shape of the embodiment, namely, such a shape that a fixing section 12 has rounded tips of projections and rounded depressions and a slope forward of the tip of each projection is slanted more gently than a slope backward is slanted. Also, as a comparative example, there is prepared a press-fit terminal 1 having such a shape that a fixing section is formed by only straight lines and tips and depressions are angular. Also, as a comparative example 2, there is prepared a press-fit terminal 1 in which a fixing section 12 is formed by curves but slopes forward and backward of the tip of each projection are formed to be the same.

Next, terminal holding powers are obtained by press-fitting the terminal of the example and the terminal of each of the comparative examples 1 and 2 into an insulating housing 2.

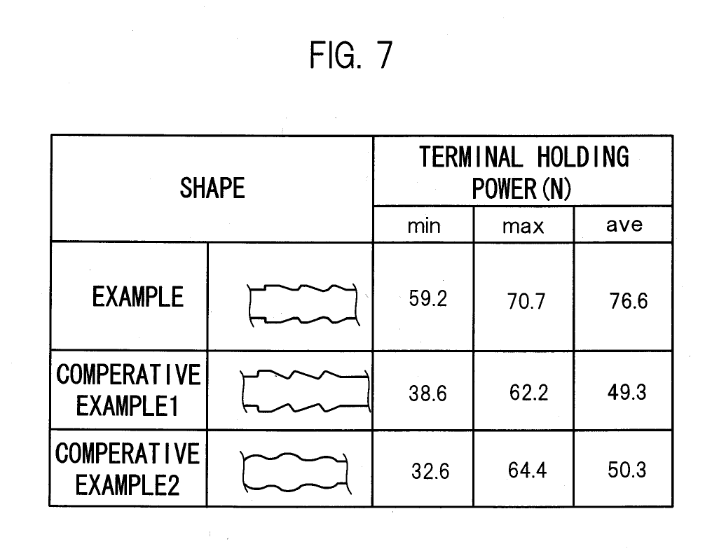

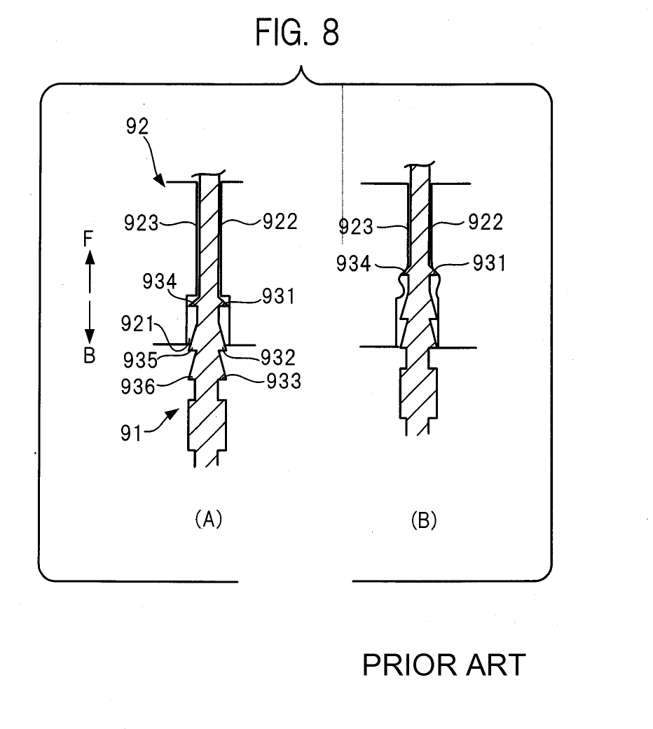

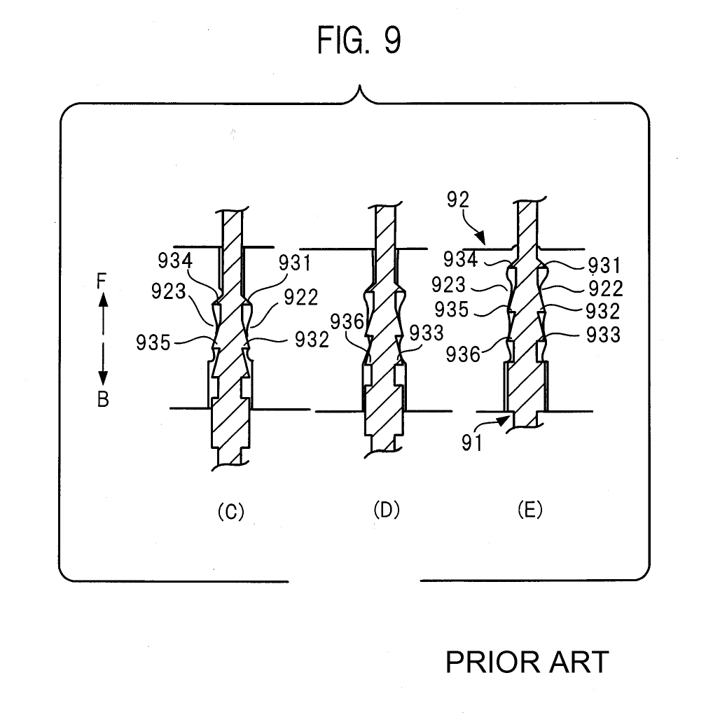

FIG. 7 is a table that shows the terminal holding power of the terminal according to each of the embodiment and comparative examples 1 and 2.

As shown in the table of FIG. 7, the terminal of the example had a terminal holding power larger than those of the comparative examples 1 and 2.

Incidentally, in the above-described embodiment, there has been described the electrical connector as an instance, but the press-fit terminal 1 and the terminal press-fitting structure of the present invention are not limited to the electrical connector and can be applied to various components having a structure in which a press-fit terminal 1 is press-fit into an insulator.

Further, in the above-described embodiment, there has been described the case in which three projections are provided on either side of the press-fit terminal 1, i.e. six projections in total. However, the present invention is not limited thereto and projections may be provided only on one side instead of being provided on either side of a press-fit terminal 1. Also, the number of projections may be even number or odd number other than six.

Furthermore, in the above-described embodiment, there has been described the case in which the press-fit terminal 1 is provided with the offset section 13, but the present invention is not limited thereto and can be applied to a press-fit terminal 1 of a type having no offset section.

Besides these, the configurations described in the above-described embodiment can be selected optionally or can be changed appropriately in to other configurations without departing from the spirit and scope of the present invention.

1. A press-fit terminal comprising:
a fixing section;
a plurality of projections positioned along the fixing section and engageable with an inner surface of a receiving passageway when the press-fit terminal is press-fit, the plurality of projections being aligned in the press-fit direction while protruding in a direction crossing a press-fit direction of the press-fit terminal;
tips being rounded and located on the plurality of projections; and
depressions being rounded and positioned between the plurality of projections;
wherein each of the plurality of projections has a shape that includes a slope forward of the tip that is less than a slope backward of the tip.

2. The press-fit terminal according to claim 1, wherein among the plurality of projections, projections positioned farther backward have larger tips.

3. The press-fit terminal according to claim 1, wherein the fixing section is formed to have a waveform interfering with the inner surfaces of the receiving passageway.

4. The press-fit terminal according to claim 3, wherein the plurality of projections are positioned to have symmetry about an axis along forward and backward directions F and B.

5. The press-fit terminal according to claim 1, further comprising a contact section positioned forward from the fixing section.

6. The press-fit terminal according to claim 5, further comprising an offset section positioned adjacent to the fixing section and formed to be wider than the contact section and the fixing section.

7. The press-fit terminal according to claim 6, further comprising a connection section located adjacent to the offset section.

8. A terminal press-fitting structure, comprising
an insulating housing having a receiving passageway; and
a press-fit terminal which is press-fit forward into the receiving passageway formed in the insulating housing and fixed to the insulating housing, having:
a fixing section;
a plurality of projections positioned along the fixing section and engageable with an inner surface of the receiving passageway when the press-fit terminal is press-fit, the plurality of projections being aligned in the press-fit direction while protruding in a direction crossing a press-fit direction of the press-fit terminal;
rounded tips located on the plurality of projections; and
rounded depressions positioned between the plurality of projections;
wherein each of the plurality of projections has a shape that includes a slope forward of the tip that is more gently slanted than a slope backward of the tip.

9. The press-fit terminal according to claim 8, wherein among the plurality of projections, projections positioned farther backward have larger tips.

10. The press-fit terminal according to claim 8, wherein the fixing section is formed to have a waveform interfering with the inner surfaces of the receiving passageway.

11. The press-fit terminal according to claim 10, wherein the plurality of projections are positioned to have symmetry about an axis along forward and backward directions F and B.

12. The press-fit terminal according to claim 8, further comprising a contact section positioned forward from the fixing section.

13. The press-fit terminal according to claim 12, further comprising an offset section positioned adjacent to the fixing section and formed to be wider than the contact section and the fixing section.

14. The press-fit terminal according to claim 13, further comprising a connection section positioned adjacent to the offset section.

15. The terminal press-fitting structure according to claim 8, wherein the insulating housing has a chamfer at a rear end of the inner surface of the receiving passageway.

16. The terminal press-fitting structure according to claim 15, wherein the chamfer is angled to be open in a backward direction.

17. The terminal press-fitting structure according to claim 14, wherein the insulating housing has a chamfer at a rear end of the inner surface of the receiving passageway, the chamfer being angled to be open backward.

18. An electrical connector comprising:
an insulating housing having a receiving passageway; and
a press-fit terminal which is press-fit forward into the receiving passageway formed in the insulating housing and fixed to the insulating housing, having:
a fixing section;
a plurality of projections positioned along the fixing section and engageable with an inner surface of the receiving passageway when the press-fit terminal is press-fit, the plurality of projections being aligned in the press-fit direction while protruding in a direction crossing a press-fit direction of the press-fit terminal;
rounded tips located on the plurality of projections; and
rounded depressions positioned between the plurality of projections;
wherein each of the plurality of projections has a shape that includes a slope forward of the tip that is more gently slanted than a slope backward of the tip.

19. The press-fit terminal according to claim 18, wherein among the plurality of projections, projections positioned farther backward have larger tips.

20. The press-fit terminal according to claim 18, wherein the fixing section is formed to have a waveform interfering with the inner surfaces of the receiving passageway.

21. The press-fit terminal according to claim 20, wherein the plurality of projections are positioned to have symmetry about an axis along forward and backward directions F and B.

22. The press-fit terminal according to claim 18, further comprising a contact section positioned forward from the fixing section.

23. The press-fit terminal according to claim 22, further comprising an offset section positioned adjacent to the fixing section and formed to be wider than the contact section and the fixing section.

24. The press-fit terminal according to claim 23, further comprising a connection section located adjacent to the offset section.
